(19) United States
(12) Patent Application Publication
(10) Pub. No.: US 2008/0105151 A1
(43) Pub. Date: May 8, 2008

(54) Conditioning Device

(75) Inventor: Hermann Gefke, Neetze (DE)

Correspondence Address: Steven M Hertzberg;Abelman Frayne & Schwab, 10th Floor, 666 Third Avenue, New York, NY, 10017-5621, US

(73) Assignee: LG Electronics Inc., Seoul (KR)

(21) Appl. No.: 10/557,719

(22) PCT Filed: Apr. 24, 2004
(86) PCT No.: PCT/EP04/04357

§ 371 Date: Feb. 28, 2006

(30) Foreign Application Priority Data
May 20, 2003 (DE) 10323051.3

(51) Int. Cl. B41F 22/00

(52) U.S. Cl. 101/424.1

(57) ABSTRACT

In order to specify a conditioning device for pages and/or printing sheets, in particular printed sheets (6), which in particular is part of a collecting and delivering device (1) for collecting and stacking printed sheets (6) and/or pages suspended on supply rolls, preferably from inkjet printers (2), having means for preventing impairment of the quality of the characters or symbols printed on the pages and/or printed sheets (6) because of incompletely dried ink, in which the stacking of printed sheets (6) and/or pages is made possible without impairment to quality in a manner which is rapid and technically as simple as possible, in order to prevent impairment to quality, the conditioning device is to have a heating module (4) having at least one heating roll (11) provided with a heating element.

### FIELD OF THE INVENTION

The invention relates to a conditioning device for pages and/or printing sheets, in particular printed sheets.

More specifically, the present invention relates to a conditioning device which is part of a collecting and delivering device for collecting and stacking printed sheets and/or pages suspended on supply rolls, preferably from inkjet printers, having means for preventing impairment of the quality of the characters or symbols printed on the pages and/or printed sheets because of incompletely dried ink.

### BACKGROUND OF THE INVENTION

A collecting and delivering device of this type is known, for example, from DE 698 04 041 T2 (EP 0873876). The collecting and delivering device described therein is constructed in such a way that, in order to prevent incompletely dried ink smearing as a result of stacking a plurality of not yet completely dried or fixed printouts on one another, means are provided which delay the stacking, until the ink on the printout on which the further printout is to be stacked has dried completely.

The disadvantage with these collecting and delivering devices is that the stacking speed is reduced by introducing a delay, which is chosen in accordance with the drying time. The effective printing speed of the printer in conjunction with the collecting and delivering device is therefore lower than the printing speed of the printer itself. For printers which are equipped with such a collecting and delivering device, it has been observed that it is disadvantageously possible for fewer printed sheets and/or pages to be printed out per unit time, than the number that corresponds to the printing speed of the inkjet printer itself.

Furthermore, it is disadvantageous that, particularly when used in conjunction with large-format printing, stacking is virtually impossible because of the curvature of the printed sheets and/or pages caused by the storage of the printed sheets and/or pages on supply rolls. Because of this curvature, stacked printouts have, for example, a substantially higher stacking height than that corresponding to the sum of the sheet thicknesses. In the case of a particularly severe curvature, the disadvantage is that direct stacking of the printed sheets and/or pages is even impossible. It is therefore disadvantageously possible not to stack any printouts or to stack only very few printouts with a given collecting and delivering device height. The curvature prevents the implementation of technically simple stacking of the printed sheets, caused by the tendency to roll up again.

### SUMMARY OF THE INVENTION

An embodiment of the present invention therefore has the object of specifying a conditioning device of the type mentioned at the beginning which permits the stacking of printed sheets and/or pages without impairment to quality in a manner which is rapid and technically as simple as possible.

The invention achieves this object in that, in order to prevent impairment of quality, the conditioning device has a heating module having at least one heating roll provided with a heating element.

As a result, the drying time of the ink on the printed sheet is advantageously shortened actively by the heat energy input, which means that the stacking of the printed sheets can be carried out earlier. This advantageously increases the effective printing speed of the printing system.

One advantageous refinement of the invention provides for the heating roll to be provided with a non-stick coating, the non-stick coating preferably consisting of polytetrafluoroethylene (PTFE). By means of the non-stick coating, the transfer of ink to the heating roll during the drying operation is advantageously avoided. This produces the advantageous results that the amount of ink applied to the printed sheet is not reduced, and that ink remains on the heating roll and is not transferred in an undesired manner to the printed sheet or to the following printed sheets at another point. In addition, the occurrence of problems as a result of the printed sheet sticking to the heating roll as the printed sheet is output is advantageously avoided. The desired requirements on the non-stick coating are particularly advantageously fulfilled by the use of polytetrafluoroethylene, for example Teflon®.

In a development of the invention, the heating roll is constructed such that it can be driven indirectly via a transport belt, the transport belt preferably being constructed as an endless belt tensioned over two rolls. By choosing an indirect drive of the heating roll, it is possible to ensure particularly effectively that the printed sheet does not slip relative to the area of contact with the heating roll, which advantageously ensures that the still wet ink does not smear on the printed sheet. As a result of tensioning the transport belt over the two rolls, the advantage additionally results that the printed sheets are in contact with the transport belt over the entire free length of the latter between the rolls. As a result, the conveyance is advantageously particularly secure with regard to uniform, slip-free conveyance.

A particularly beneficial embodiment results if the non-stick coating provided on the heating roll is shaped in such a way that the friction between the printed sheet and/or pages and the heating roll is greater than the friction between the printed sheets and/or pages and the transport belt. This choice of the coefficients of friction advantageously ensures that, during accelerations and/or retardations of the transport belt, sliding of the printed sheet against to the heating roll does not occur in any case. Instead, during accelerations and retardations of the transport it is merely sliding of the transport belt against the underside of the printed sheet that occurs, whereas the printed sheet, unaffected thereby, is connected to the heating roll by adhesive friction. It is therefore advantageously possible for only the unit comprising printing sheet and heating roll to be accelerated and retarded to the same extent.

According to the invention, it is particularly beneficial if the non-stick coating provided on the heating roll is molded in such a way that the friction between the heating roll and the transport belt is lower than the friction between the printed sheets and/or pages and the transport belt. This frictional system ensures that no drive of the heating roll which leads to a relative movement on the printed sheet can occur. In the case of narrow originals, for example printing material with a width of 200 mm, and a total width of the transport belt and of the heating roll of the conditioning device of, for example, 1000 mm, which originals are therefore narrower than the heating roll, the transport belt would otherwise also drive the heating roll. As a result, it would be possible for smearing of not yet dried ink on the printed side of the printed sheets to occur. This is advantageously prevented by the aforementioned choice of the non-stick coating.

In a very beneficial variant of the invention, the heating roll is configured in such a way that the printed sheets and/or pages touch the latter under pressure and, in the process, compensate for the inherent direction of curvature impressed on the printed sheets and/or pages by the supply roll. In this way, by means of the invention, a further disadvantage of the known collecting and delivering devices is a surprisingly eliminated. The heat energy transferred to the printed sheets by the heating roll is thus advantageously used both to shorten the drying time of the ink and also to cancel the inherent curvature of the printed sheets. By means of this arrangement, it is thus a possible for flat printed sheets to be produced, which have the advantage of a considerably better stacking unit.

A specific variant of the invention provides for the heating module to be equipped with an output roll at the end of the transport path. This is beneficial for conveying the printed sheets out of the heating module. The use of an additional output roll specifically for the conveyance out of the heating module advantageously ensures a more uniform, more corrugation-free transport of even relatively long or relatively fine printed sheets than is the case if the conveyance of the printed sheets both in and out is carried out with the transport, since the printed sheets are advantageously pulled by the output roll instead of being pushed from the rear.

It is very beneficial if the output roll is provided with a knob-like sheath, the sheath preferably enclosing the output roll completely and/or covering individual segments of the output roll. In this way, a surface with friction is advantageously produced on the output roll, which makes transport easier without damaging the printed sheets in the process.

According to a specific development of the invention, the output roll is provided on an output side with hold-down and guide means acting on the printed sheets and/or pages from above, the hold-down and guide means preferably consisting of plastic strips. As a result, corrugation of the printed sheet before stacking can advantageously be prevented. For example, these hold-down and guide means can be used to lead the printed sheets, which are not curved because of the action from the heating module, to a stack delivery plate. In this case, damage to the printed sheets as a result of uncontrolled bending is advantageously avoided.

The use in particular of plastic strips as hold-down and guide means is particularly beneficial, since these are flexible and in this way damage to the printed sheets is avoided particularly effectively.

A specific refinement of the invention provides for the heating roll to be provided with at least one temperature sensor. Since the temperature has to be kept within a specific interval in order to ensure the functioning of the collecting and delivering device, it is advantageous to monitor the temperature continuously with a sensor. For example, it is very beneficial to use the measured temperature as an input variable for a temperature control system. The temperature should not be too high, since damage to the printed sheets could occur, nor may the temperature be too low since, in the event of an excessively low temperature, the drying of the ink would not be carried out quickly enough or the compensation for the inherent curvature of the printed sheets could not take place.

One advantageous implementation of the invention is for a delivery plate for printed sheets and/or pages to be arranged after the heating module in the transport direction. The printed sheets coming out of the heating module can advantageously be stacked on the delivery plate.

A particularly beneficial development according to the invention provides for the delivery plate to be configured to be spring mounted by means of compression springs, at least on the input side and preferably also on the removal side. In this case, the spring constant is preferably chosen such that the change in the spring travel caused by the weight of the printed sheet corresponds exactly to the thickness of the printed sheet. In this way, the already stacked printed sheets are advantageously kept at a constant level at the top. As a result, further printed sheets can advantageously be put onto the already stacked printed sheets in an optimal manner without any offset having to be overcome in the process. Further, springs can additionally be fitted on the removal side, such that the delivery plate is always aligned at the same angle with respect to the horizontal, which advantageously leads to constant height relationships for the delivery of each further printed sheet.

A development of the invention provides for the delivery plate to be arranged flush with a guide plane of the printed sheets and/or pages within the heating module. This advantageous change ensures that, at the transition of the printed sheets from the heating module to the delivery plate, no offset has to be overcome. This results in the advantage that the risk of damage to printed sheets during the transition, for example as a result of catching on this offset or of, scratching along this offset, is circumvented to the greatest possible extent.

According to a specific design variant of the invention, a delivery plate extension is advantageously arranged after the delivery plate and is preferably constructed such that it can be folded down and/or is arranged to be inclined downward. This extension has the advantage that it is also possible for printed sheets which are longer than the delivery plate itself to be stacked by the collecting and delivery device. This advantageously increases the range of use of the invention. The design as an extension that can be folded down additionally has the advantage of saving space. If, in addition, the delivery plate extension is inclined downward, by utilizing the action of the force of gravity on the printed sheet newly to be stacked, the friction of this printed sheet with the printed sheets already stacked and/or with the delivery plate is advantageously compensated for. This has the advantage that, for example, undesired corrugation in the printed sheet during conveyance is avoided.

In a further refinement of the invention, the heating module is preferably connected to the inkjet printer via a printed sheet and/or page feed unit. In this manner, the collecting and delivery device can advantageously be used as an independent device with any desired printer, since a flush arrangement of the heating module with the printer is produced via the feed unit. In addition, the advantage of a printed sheet feed unit according to the invention is that the latter can be synchronized with the printer, which ensures that the printed sheets cannot be damaged by, for example, different conveying speeds in the printer and in the collecting and delivery device as a result of bending up or the like.

In a development of the invention, the printed sheet and/or page feed unit is equipped with a control flap which is mounted on one side on the conveying input and touches the printed sheet and/or page plane. The page feed unit is intended to prevent any excessive tensile stress acting on the printed sheets and/or pages between printer and conditioning device. The control flap is urged upward by a spring. When the control flap is deflected downward, a sensor is actuated and the forward drive within the stacking unit is stopped. When the control flap rises again, which is caused by material pushed forward, the sensor is switched again and the forward drive is started. In this manner, it is advantageously possible to prevent the printed sheets being damaged by excessive tensile stress on the latter.

With this control flap, the feeding of further printed sheets can advantageously be suppressed in specific operating states of the collecting and delivery device. This is important, for example, if, during the removal of already collected printed sheets from the collecting and delivery device, it is intended to prevent further printed sheets being conveyed onto the collecting and delivery device at the same time, since damage to the printed sheets could occur as a result.

In this case, it is very beneficial if the control flap is provided with at least one control flap position sensor with which, for example, it is possible to detect whether there is a printed sheet in the feed unit at a specific time. This information can advantageously be used for example for the synchronization, in that for example the further feeding of printed sheet from the printer is suppressed until there is no longer any printed sheet in the feed unit.

### BRIEF DESCRIPTION OF THE DRAWINGS

The invention will be described by way of example in a preferred exemplary embodiment with reference to the drawings, it being possible for further advantageous details to be gathered from the figures.

Functionally identical parts are provided with the same element numbers.

In the figures of the drawing, in detail:

FIG. 1 shows an overall view of the collecting and delivery device in conjunction with an inkjet printer;

FIG. 2a shows an overall view of the empty collecting and delivery device;

FIG. 2b shows an overall view of the filled collecting and delivery device; and

FIG. 3 shows a detailed view of the collecting and delivery device.

### DETAILED DESCRIPTION OF THE INVENTION

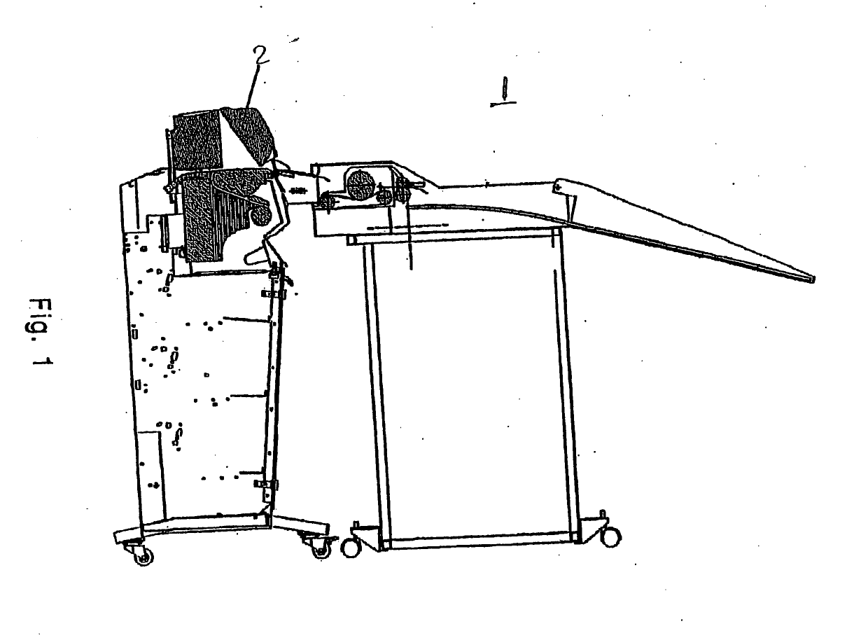

In FIG. 1, the complete collecting and delivery device 1 connected to the inkjet printer 2 is shown.

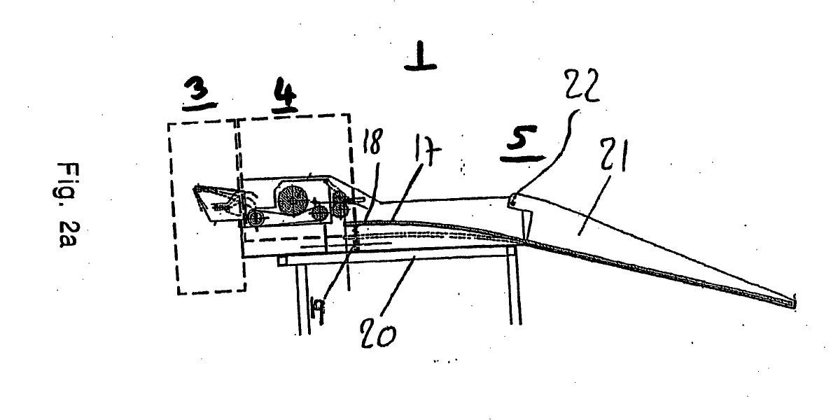

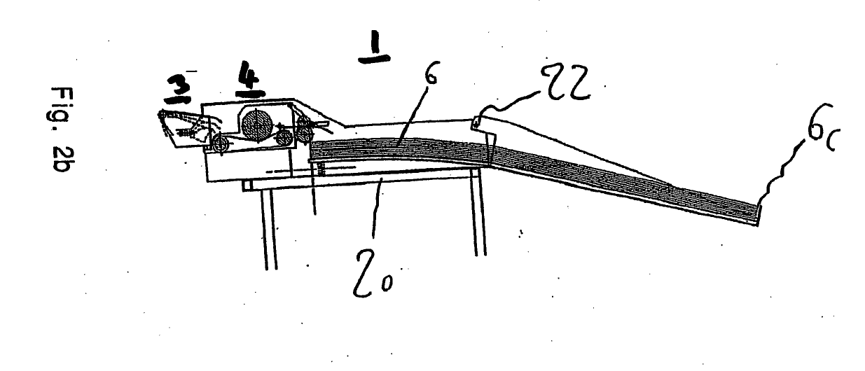

FIG. 2a shows an overall view of the collecting and delivery device 1 comprising the printed sheet feed unit 3 fitted between the inkjet printer 2 and the collecting and delivery device 1, the heating module 4 arranged after said feed unit and the delivery unit 5 arranged after the heating module 4.

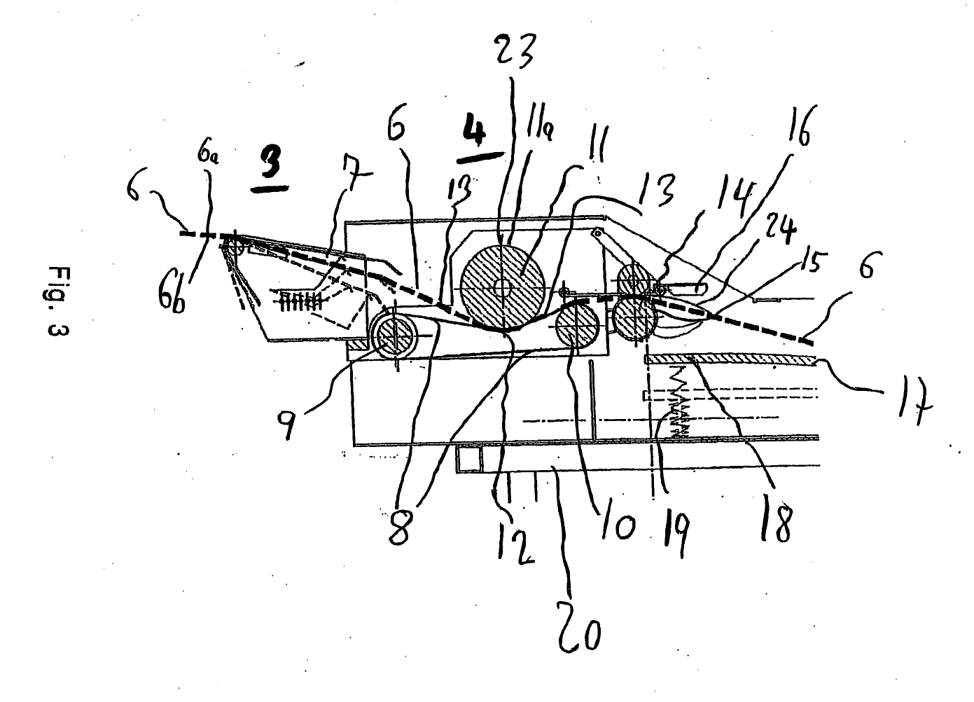

As can be seen in FIG. 3, the printed sheet 6 is clamped in the collecting and delivery device. The printed sheet 6 runs past the control flap 7 of the feed unit 3, and is clamped in between the transport belt 8 tensioned on the first and second transport roll 9 and 10, respectively, and the heating roll 11, along the contact surface 12. The Teflon coating 11a of the heating roll 11 prevents ink on the printed top side 6a of the printed sheet 6 adhering to the heating roll 11.

As a result of the rotation of the drive rolls 9 and 10, the printed sheet 6 is conveyed through the heating roll 11 as a result of the friction between the contact area 12 of the printed top side 6a of the printed sheet 6 and the transport belt 8. The friction between the heating roll 11 and the printed top side 6a of the printed sheet 6 is greater than the friction between the unprinted underside 6b and the transport belt 8. The friction between the heating roll 11 and the transport belt 8 is lower than the friction between the unprinted underside 6b of the printed sheet 6 and the transport belt 8.

In the process, the ink on the printed original 6 dries as a result of the thermal energy transferred to the printed original 6 by the heating roll 11. In the process, the printed sheet 6 experiences a curvature 13 opposed to its inherent direction of curvature impressed by the supply roll. The temperature sensor 23 measures the temperature of the heating roll 11. After the heating roll 11 and the second transport roll 10 there is the output roll 14, whose surface is provided with knobs 15. Fitted to the output roll 14 are plastic strips 16, which guide the printed sheet 6 in the direction of the delivery plate 17, and also an output detection sensor 24.

The delivery plate 17 is mounted on compression springs 19 on the front side 18. The delivery unit 5 and part of the heating module 4 are mounted on the subframe 20.

As can be seen in FIGS. 2a and 2b, the delivery plate extension 21 on the delivery plate 17 can be folded down at a hinge 22.

Following an exemplary application of the invention, the printed sheet 6 output from the inkjet printer 2 is transported to the heating module by the feed unit 3. In this case, the feed is controlled by the control flap 7. In the heating module 4, the printed sheet 6 is clamped in between the transport belt 8 and the heating roll 11. In this case, the printed sheet 6 is given a curvature 13 opposite to its inherent direction of curvature impressed by the supply roll. At the contact area 12 between the printed top side 6a of the printed sheet 6 and the heated Teflon layer 11a of the heating roll 11, the still wet ink on the printed top side 6a is dried. At the same time, the inherent curvature of the printed sheet 6 caused by the storage on supply rolls is cancelled as a result of the action of heat from the heating roll 11 on the printed sheet 6 in the direction of the curvature 13 caused by the clamping in between the heating roll 11 and the transport belt 8. The temperature in the heating roll is monitored continuously by the temperature sensor 23 as an input variable for the temperature control system.

Then, by means of the interplay between the transport belt 8 and the output roll 14 provided with the knobs 15, the printed sheet is transported onward. In the process, the plastic strips 16 guide the printed sheet 6 downward in the direction of the delivery plate 17.

The front side 18 of the delivery plate 17 sinks down by the distance corresponding to the thickness of the printed sheet 6 after the printed sheet 6 has been delivered onto the delivery plate 17, as a result of the action on the compression springs 19 of the additional weight caused by the printed sheet 6. The printed sheet 6 is transported over the delivery plate over its complete length by the output roll 14, until the start (leading edge) 6c of the printed sheet 6 reaches the end of the delivery plate extension 21 folded up via the hinge 22. The output detection sensor 24 detects that the end (trailing edge) of the printed sheet 6 has been reached. This signal can be used to switch off the transport means.

In the matter described, according to the invention it is possible to stack a plurality of printed sheets 6 quickly and thus to increase the effective printing speed. Here, the undesired inherent curvature of the printed sheets 6 is surprisingly additionally compensated.

The printed sheets delivered in the manner described above according to the invention lie flat, the ink has been dried and/or fixed, so that immediate handling without smearing is possible.

I claim:

1. A conditioning device for pages and/or printing sheets (6), in particular printed sheets, characterized in that, in order to prevent impairment to quality, the conditioning device has a heating module (4) having at least one heating, roll (11) provided with a heating element.

2. The conditioning device as claimed in claim 1, characterized in that it is provided in a printer.

3. The conditioning device as claimed in claim 1, characterized in that it is provided in a collecting and delivery device (1) for collecting and stacking printed sheets (6)and/or pages suspended on supply rolls, preferably from inkjet printers (2).

4. The conditioning device as claimed in claim 1, characterized in that the heating roll (11)is provided with a non-stick coating (11a), the non-stick coating (11a) preferably consisting of polytetrafluoroethylene.

5. The conditioning device as claimed in claim 1, characterized in that the heating roll (11) is constructed such that it can be driven indirectly via a transport belt (8), the transport belt (8) preferably being constructed as an endless belt tensioned over two rolls (9, 10).

6. The conditioning device as claimed in claim 5, characterized in that the non-stick coating (11a) provided on the heating roll (11) is molded in such a way that the friction between the printed sheets (6) and/or the pages and the heating roll (11) is greater than the friction between the printed sheets (6) and/or pages and the transport belt (8).

7. The conditioning device as claimed in claim 5, characterized in that the non-stick coating (11a) provided on the heating roll (11) is molded in such a way that the friction between the heating roll (11) and the transport belt (8) is lower than the friction between the printed sheets (6) and/or pages and the transport belt (8).

8. The conditioning device as claimed in claim 1, characterized in that the heating roll (11), touching the printed sheets (6) and/or pages under pressure, is constructed so as to compensate for the inherent direction of curvature impressed on the printed sheets (6) and/or pages by the supply roll.

9. The conditioning device as claimed in claim 1, characterized in that the heating module (11) is equipped with an output roll (14) at the end of the transport path.

10. The conditioning device as claimed in claim 9, characterized in that the output roll (14) is provided with a knob-like sheath (15), the sheath (15) preferably enclosing the output roll (14) completely and/or covering individual segments of the output roll (14).

11. The conditioning device as claimed in claim 9, characterized in that the output roll (14) is provided on an output side with hold-down and guide means (16) acting on the printed sheets (6) and/or pages from above, the hold-down and guide means (16) preferably consisting of plastic strips.

12. The conditioning device as claimed in claim 1, characterized in that the heating roll (11) is provided with at least one temperature sensor (23).

13. The conditioning device as claimed in claim 1, characterized in that a delivery plate (17) for printed sheets (6) and/or pages is arranged after the heating module (11) in the transport direction.

14. The conditioning device as claimed in claim 13, characterized in that the delivery plate (17) is configured to be spring mounted by means of compression springs (19), at least on the input side (18) and preferably also on the removal side.

15. The conditioning device as claimed in claim 13, characterized in that the delivery plate (17) is arranged flush with a guide plane of the printed sheets (6) and/or pages within the heating module (4).

16. The conditioning device as claimed in claim 13, characterized in that a delivery plate extension (21) is arranged after the delivery plate (17) and is preferably constructed such that it can be folded down and/or is arranged to be inclined downward.

17. The conditioning device as claimed in claim 3, characterized in that the heating module (4) is connected to the preferably inkjet printer (2) via a printed sheet and/or page feed unit (3).

18. The conditioning device as claimed in claim 17, characterized in that the printed sheet and/or page feed unit (3) is equipped with a control flap (7) which is mounted on one side on the conveying input and touches the printed sheet and/or page plane, the control flap (7) preferably being provided with at least one control flap position sensor.
